(19) United States
(12) Patent Application Publication
(10) Pub. No.: US 2004/0186399 A1
(43) Pub. Date: Sep. 23, 2004

(54) Leg massage installation

(76) Inventor: Jung-Chun Tseng, Taoyuan City (TW)

Correspondence Address: TROXELL LAW OFFICE PLLC, SUITE 1404, 5205 LEESBURG PIKE, FALLS CHURCH, VA, 22041, US

(21) Appl. No.: 10/388,585

(22) Filed: Mar. 17, 2003

(51) Int. Cl. A61H 15/00

(52) U.S. Cl. 601/112; 601/126; 601/133; 601/136

(57) ABSTRACT

A leg massage installation comprised of a roller to massage nerve centers on the foot; two pressboards fixed to the peripheral of a cam disk; the center of the camdisk being inserted onto a spherical part of a linkage shaft; a drive disk each fixed to both sides of the linkage shaft; one end of the linkage shaft being incorporated to the roller by means of a shift mechanism; the turning roller to drive the linkage shaft for reciprocal turning through the shift mechanism, and the drive disk twists for both pressboards to reciprocally swing towards the roller massage nerve centers on the feet and leg muscles.

### BACKGROUND OF THE INVENTION

(a) Field of the Invention

The present invention is related to an installation of leg massage, and more particularly, to one that massages one's nerve centers located on the feet and relax leg muscles to stimulate the feet and ease tense leg muscles for improving one's circulation system, thus to achieve the purpose of curing the soar legs.

(b) Description of the Prior Art

People who have to stand for long hours while working suffer soar feet and legs since while standing, central gravity forces one's blood to continuously compress against feet or legs; and in serious case, many after effects including poor circulation. There are many installations available in the market for massaging one's feet to increase blood circulation in one's legs to make fatigue thereon fading away.

The structure of most of the conventional feet massage installations is essentially comprised of a power driven roller to massage nerve centers on one's feet. The roller structure is proved most practical and convenience for use. Wherein, the roller revolves as driven by a motor at a proper rpm to allow the user having both feet stepping upon the roller. Multiple grains protruding from the surface of the roller compress against one's feet to improve blood circulation therein by stimulating nerve centers located thereon. However, the prior art massages at best one's feet and fails to satisfy the user's need for curing soar legs.

### SUMMARY OF THE INVENTION

The primary purpose of the present invention is to provide an installation of leg massage installation to cure one's soar legs. To achieve the purpose, a pressboard is each provided on both sides of a roller, which massages those nerve centers on one's feet. Both pressboards are fixed to the peripheral of a cam disk and the center of the cam disk is inserted into a linkage shaft. A drive disk is each fixed to of the linkage shaft at where in relation to the both sides of the surface of the cam disk. A shift mechanism is provided to one end of the linkage shaft relatively to the roller for the linkage shaft to incorporate to the roller so that when the roller is turning, the linkage shaft engages in reciprocal movement as driven by the shift mechanism while both drive disks are pushing against the camdisk to twist for both pressboards to reciprocally swing towards the roller, thus to compress the leg muscles above the roller to massage nerve centers on the feet and leg muscles.

A spherical part is provided on the rod of the linkage shaft to be inserted into the center of the cam disk for the camdisk to twist with the spherical part as the axis for achieving a more consistent twisting effect. Furthermore, multiple rolling beads are provided between the drive disks and the surface of the cam disk to reduce the friction between the drive disks and the cam disk.

### BRIEF DESCRIPTION OF THE DRAWINGS

FIG. 1 is a schematic view showing the appearance of a preferred embodiment of the present invention.

FIG. 2 is an exploded view of a structure comprised of a roller, a linkage shaft and a shift mechanism in the preferred embodiment of the present invention.

FIG. 3 is a sectional view showing a structure comprised of the roller, the linkage shaft, the shift mechanism and a cam disk in the preferred embodiment of the present invention showing

FIG. 4 is a schematic view showing that two pressboards swing towards the roller in one operation mode of the preferred embodiment of the present invention.

FIG. 5 is a schematic view showing that those two pressboards swing away from the roller in the operation mode of the preferred embodiment of the present invention.

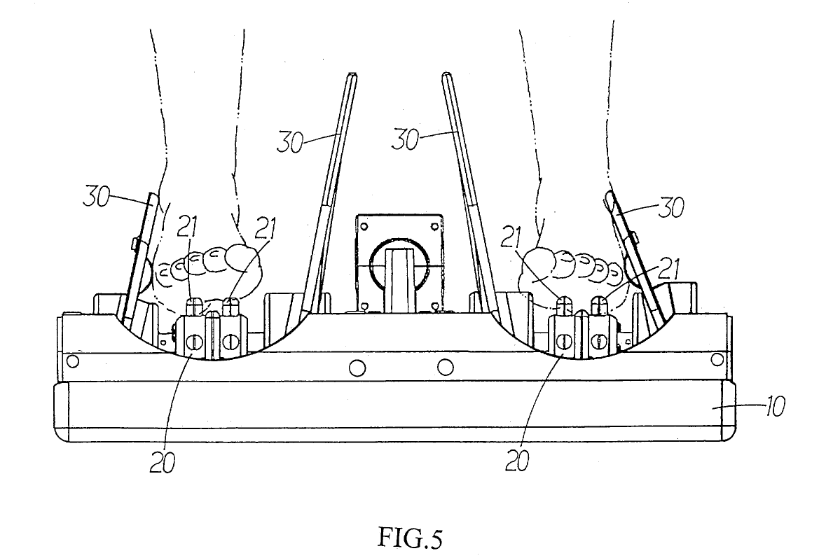

FIG. 6 is a schematic view showing that two pressboards swing towards the roller in another operation mode of the preferred embodiment of the present invention.

FIG. 7 is a schematic view showing that those two pressboards swing away from the roller in another operation mode of the preferred embodiment of the present invention.

### DETAILED DESCRIPTION OF THE PREFERRED EMBODIMENTS

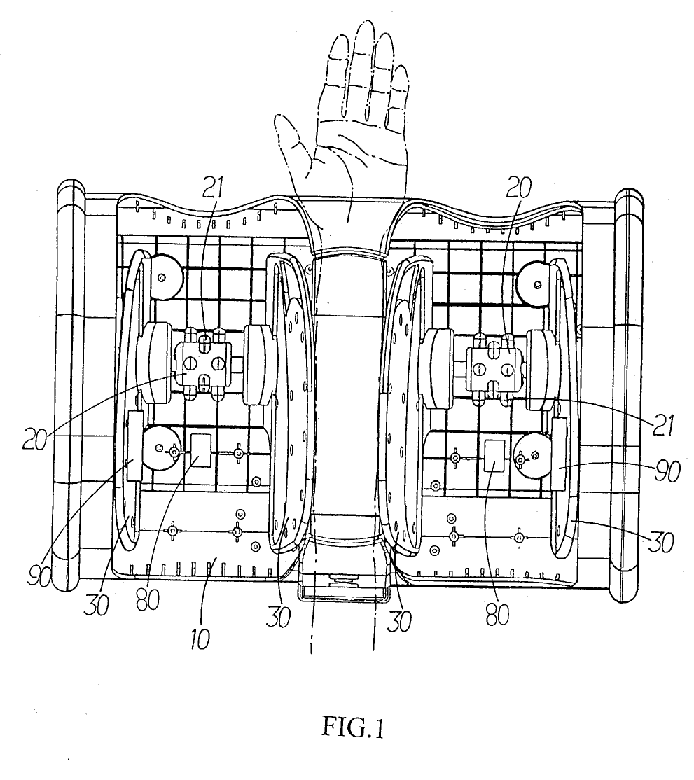

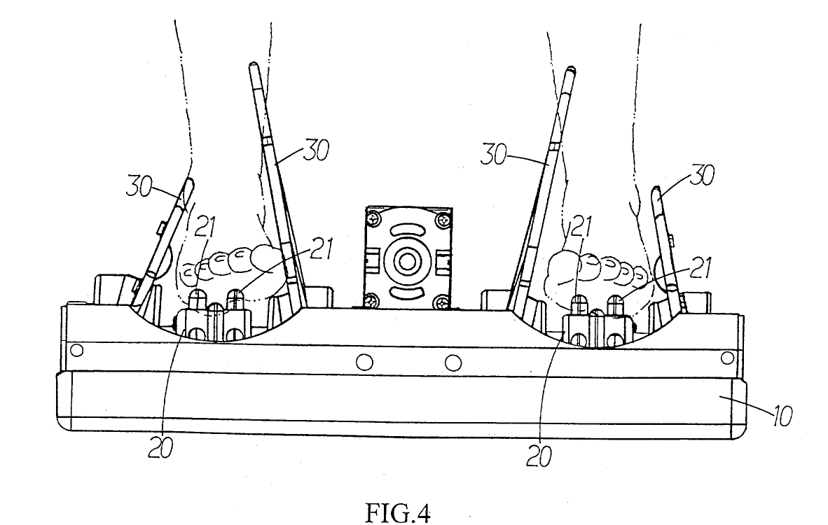

Referring to FIG. 1, a preferred embodiment of the present invention is essentially comprised of a holder (10) to accommodate a drive mechanism (not illustrated) driven by a motor (M) to facilitate the motor (M) to drive a roller (20) provided on the holder (10) to turn. Multiple grains (21) are protruding from the surface of the roller (20) so that when the present invention is in use as illustrated in FIG. 4, the user steps upon the turning roller (20) for those grains (21) to compress on to the feet thus to simulate multiple nerve centers located on the feet.

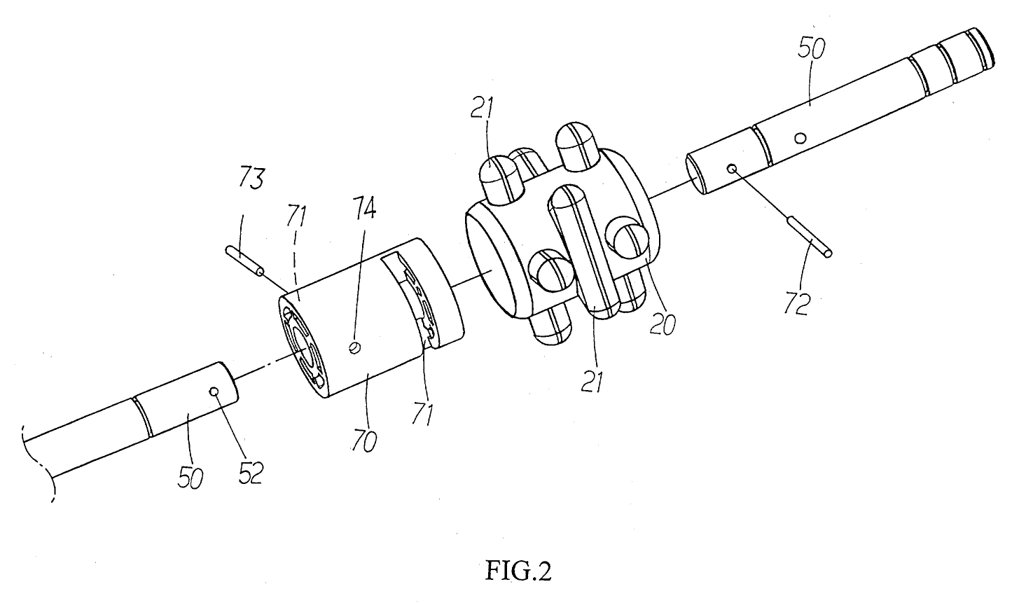

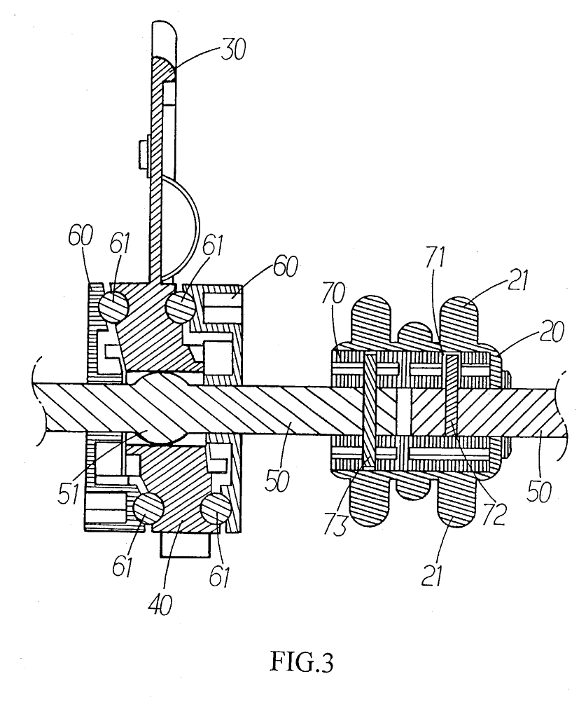

As illustrated in FIGS. 2 and 3, a pair of pressboards (30) is each provided on both sides of the roller (20) and respectively fixed to the circumference of a cam disk (40) with the center of the cam disk (40) inserted with a spherical part (51) of the rod of a linkage shaft (50). A drive disk (60) is each fixed to the linkage shaft (50) at where relatively to both sides of the surface of the cam disk (40) and one end of the linkage shaft (50) in relation to the roller (20) is incorporated by means of a shift mechanism (7) to the roller (20). The shift mechanism (70) is provided with a 180-degree insertion trough (71) and the roller (20) is incorporated to the linkage shaft (50) by having a pin (72) inserted through the insertion trough (71) on one side of the roller (20). On the other side of the roller (20), a fixation bolt (73) penetrates through a fixation hole (52) and a positioning hole (74) for the linkage shaft to stay in position in the shift mechanism (70), so that both press boards (30) to become in parallel with each other by simultaneous clamping in and loosening up while the linkage shaft (50) is executing a 180-degree reciprocal turning. The space between the drive disk (60) and the cam disk (40) is lined with multiple rolling beads (61) to reduce friction between the drive disk (60) and the cam disk (40).

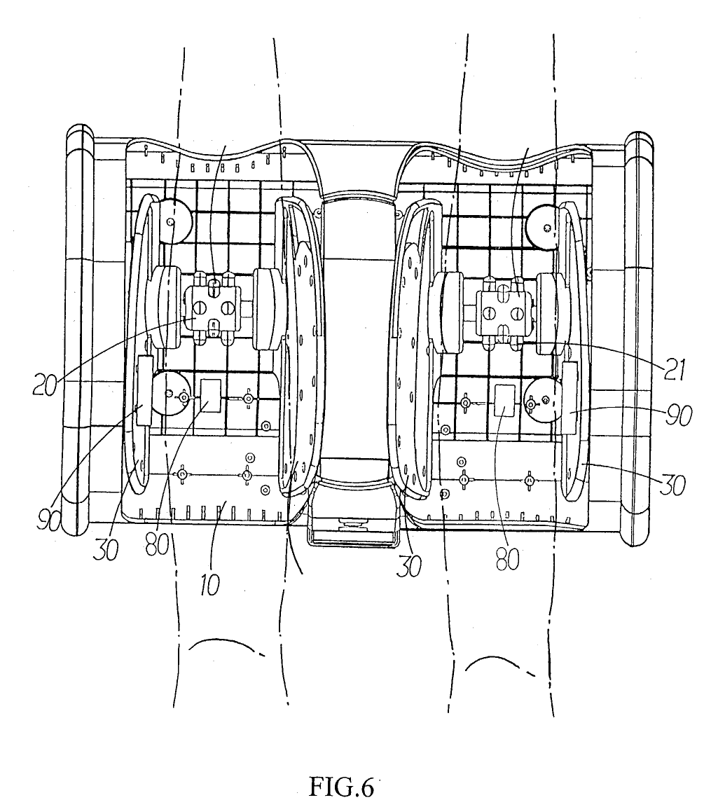

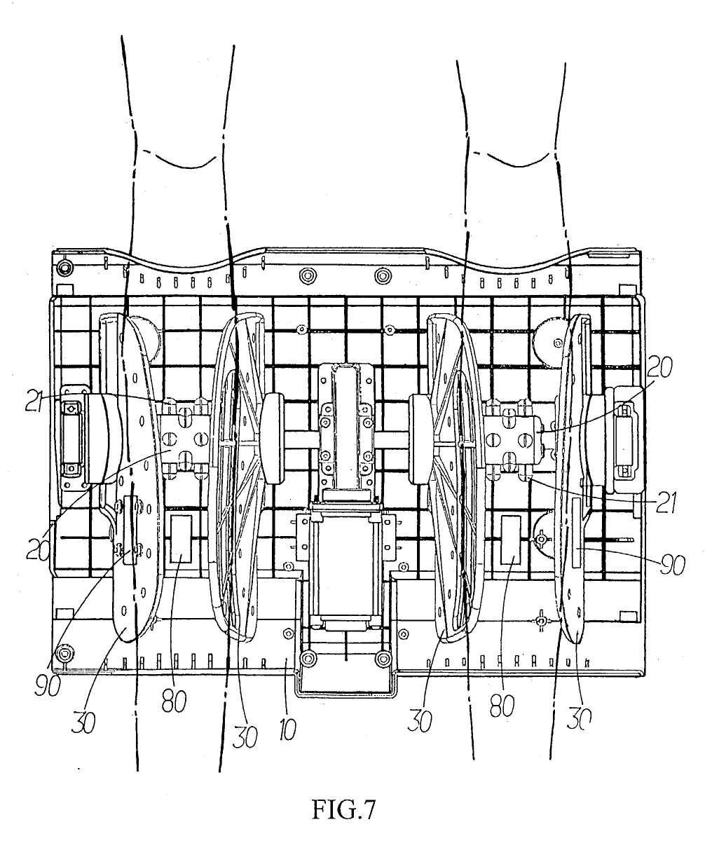

When the roller (20) turns, the linkage shaft (50) is driven at the same time by the shift mechanism (70) to engage in reciprocal turning, and the roller (20) twists with the spherical part (51) as the axis while the driving disk (60) is pushing against the cam disk (40). When the motor (M) revolves in positive orientation as illustrated in FIGS. 4, 6 and 7, both pressboards (30) swing reciprocally towards the roller (20) to execute clamping in and loosening up cycle so to massage leg muscles of the user stepping on the roller (20). Meanwhile, the roller (20) is massaging those nerve centers on the foot to stimulate blood circulation. On the other hand, when the motor (M) revolves in negative orientation, both pressboards (30) are in parallel with each other as the linkage shaft (50) engages in a 180-degree turning by means of the shift mechanism (70) so to massage the foot and the leg at the same time.

Naturally, the present invention is comprised of two rollers (20) and two pairs of pressboards (30) to massage both legs. As illustrated in FIG. 1, the user may have his either arm rested between the pressboards (30) on the inner side of both rollers (20) for the swinging pressboards to massage the arm muscles. Furthermore, a patting device (80) may be provided at where appropriately on the holder (10) to clap on the feet. A vibration device (90) may be each provided on one side of the pressboard (3) in relation to the foot so to further massage the foot by vibration when the pressboards (30) are pressing against the foot.

As disclosed above, a leg massage installation of the present invention by massaging the feet and the legs of the user at the same time is innovative and practical. Therefore, this application for a utility patent is duly filed accordingly. However, it should be noted that the preferred embodiment is given only for reference purpose and not to limit the present invention. Any structure, installation and characteristics that are resembling or similar to the present invention shall be deemed as falling with the purpose and the scope of claims to be claimed by the present invention.

I claim:

1. A leg massage installation that massages one's feet and legs at the same time is essentially comprised of a holder to accommodate holder to accommodate a drive mechanism driven by a motor to facilitate the motor to drive a roller provided on the holder to turn; multiple grains protruding from the surface of the roller to compress onto the feet thus to simulate multiple nerve centers located on the feet; pair of pressboards being each provided on both sides of the roller and respectively fixed to the circumference of a cam disk with the center of the cam disk inserted with a spherical part of the rod of a linkage shaft; a drive disk being each fixed to the linkage shaft at where relatively to both sides of the surface of the cam disk; one end of the linkage shaft in relation to the roller being incorporated by means of a shift mechanism to the roller; the shift mechanism being provided with a 180-degree insertion trough; the roller being incorporated to the linkage shaft by having a pin inserted through the insertion trough on one side of the roller; on the other side of the roller a fixation bolt penetrates through a fixation hole and a positioning hole for the linkage shaft to stay in position in the shift mechanism; so that both press boards becoming in parallel with each other by simultaneous clamping in and loosening up while the linkage shaft executing a 180-degree reciprocal turning; when the roller turns, the linkage shaft being driven at the same time by the shift mechanism to engage in reciprocal turning; the roller twists with the spherical part as the axis while the driving disk pushing against the cam disk; when the motor revolves in positive orientation, both pressboards swinging reciprocally towards the roller to execute clamping in and loosening up cycle so to massage leg muscles of the user stepping on the roller; the roller massaging those nerve centers on the foot to stimulate blood circulation; when the motor revolving in negative orientation, both pressboards being in parallel with each other as the linkage shaft engages in a 180-degree turning by means of the shift mechanism so to massage the foot and the leg at the same time.

2. A leg massage installation as claimed in claim 1, wherein, a spherical part is provided on the rod of the linkage shaft to be inserted into the center of the cam disk and the cam disk twists with the spherical part as the axis to achieve more consistent twisting results.

3. A leg massage installation as claimed in claim 1, wherein, the space between the drive disk and the cam disk is lined with multiple rolling beads to reduce friction between the drive disk and the cam disk.

4. A leg massage installation as claimed in claim 1, wherein, two rollers and two pair of pressboards are provided.

5. A leg massage installation as claimed in claim 1, wherein, a patting device is provided at where appropriately on the holder to clap on the feet

6. A leg massage installation as claimed in claim 1, wherein, a vibration device is each provided on one side of the pressboard in relation to the foot so to further massage the foot by vibration when the pressboards are pressing against the foot.
